(19) United States
(12) Patent Application Publication
(10) Pub. No.: US 2026/0202902 A1
(43) Pub. Date: Jul. 16, 2026

(54) SYSTEM AND METHOD FOR DIGITAL DISPLAY DEVICE CONTAINED ADJUSTING OF A USER INTERFACE SIZE BASED ON DISTANCE BETWEEN THE USER AND THE DIGITAL DISPLAY DEVICE

(71) Applicant: Dell Products LP, Round Rock, TX (US)

(72) Inventors: Yunyi Tan, Singapore (SG); Siew Fei Lee, Singapore (SG); Loo Shing Tan, Singapore (SG)

(73) Assignee: Dell Products LP, Round Rock, TX (US)

(21) Appl. No.: 19/025,269

(22) Filed: Jan. 16, 2025

(51) Int. Cl. G06F 3/01; G06F 3/0484; G06V 40/16

(52) U.S. Cl. CPC G06F 3/011; G06F 3/0484; G06V 40/161

(57) ABSTRACT

A system and method comprising a standalone digital display device that includes a video scaler hardware controller and a visual sensor to capture images of a user's face. The video scaler hardware controller executes computer-readable program code instructions of a facial detection module to detect facial landmarks of a user's face based on the captured images of the user's face, a facial sensing-to-distance data translator module to detect landmarks of the user's face within the facial patterns, and to detect the distance of the user's face relative to the standalone digital display device, and detect changes in distance of those facial features to generate delta distance data, and a distance data-to-user interface size module to translate the distance of the user's face to the standalone digital display device to a pixels-per-inch screen scale adjustment to adjust the size of the displayed graphical user interface features of the received video data.

### FIELD OF THE DISCLOSURE

The present disclosure generally relates to executing computer-readable program code instructions on a digital display device for automatically adjusting a screen scale of a user interface displayed on the digital display device. The present disclosure more specifically relates systems and methods for executing computer-readable program code instructions on-board a digital display device for dynamically adjusting a screen scale of a user interface based on a detected distance of the user relative to the digital display device in addition to manual display settings operated via an operating system on an operatively coupled information handling system generating the user interface.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of a graphics processing unit to provide image and video data to the digital display device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to a digital display device including a video scaler hardware controller to adjust a screen scale on the digital display device based on a detected distance of the user's face relative to the digital display device according to an embodiment of the present disclosure;

FIG. 2 is a graphic and block illustrating an information handling system operatively coupled to a digital display device including a video scaler hardware controller to adjust a screen scale on the digital display device based on a detected distance of the user's face relative to the digital display device according to another embodiment of the present disclosure;

FIG. 3 is a flow diagram showing a method of executing computer-readable program code instructions for adjusting a screen scale of a user interface according to an embodiment of the present disclosure; and

FIG. 4 is a flow diagram showing a method of executing computer-readable program code instructions for adjusting a screen scale of a user interface according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may include any number of a plurality of input and output devices that allow a user to interact with the information handling system. Among the output devices includes a standalone digital display device which may be used with an information handling system, and in some cases, in addition to an integrated display device such as for a laptop information handling system. These standalone digital display devices may include both wired and wireless digital display devices and may be one of potentially many digital display devices used by the user to receive output from the user. Additionally, these standalone digital display devices may present to a user various types of video output data including graphical user interfaces, images, graphics, and streaming videos commensurate with the output from an operatively coupled information handling system.

In some examples, these standalone digital display devices may present a graphical user interface (GUI) to a user that has a set user interface scale regardless of the user's distance from the standalone digital display device. With the advent of streaming entertainment, a user may use the digital display device as a primary entertainment device instead of purchasing a television, for example, but also for interfacing with a GUI presented by execution of a software application on an operatively coupled information handling system. The use of a standalone digital display device may also be used as a personal screen for interaction with software applications of the operatively coupled information handling system. Such a plurality of uses for such a standalone digital display device may benefit users in smaller spaces such as bedrooms or dormitories where it may be difficult to install a television and have a computer monitor. However, such a standalone digital display device may be used in many positions by the user in such spaces including leaning back in a chair, laying on a bed, or otherwise moving into a more relaxing position or more actively engaging positions in front of the standalone digital display device. These changes in position causes the user to shift between being further away from the standalone digital display device or closer to the same. Additionally, other users may be invited to view the streaming video or other content on the digital display device necessitating the group to sit further away from the screen in order to allow each user to be able to view the content presented on the digital display device. With such adjustment of position of users before the standalone digital display device, the text and icons associated with a graphical user interface (GUI) presented to the user from an executing software application on an operatively coupled information handling system remain the same size regardless of the distance of the user's face relative to the standalone digital display device. This may cause difficulty for the user to read the text and see these icons the further the user is away from the standalone digital display device. The inability to see this text and these icons of a GUI clearly may result in eye strain or mis-selection of options presented on the user interface. Currently manual display settings for adjustment of a digital display device via settings on an operatively coupled information handling system may become cumbersome, especially as the user shifts continuously in front of the standalone digital display device.

To address these and other issues, embodiments of the present specification describes a standalone digital display device that includes a video scaler hardware controller executing automatic screen scale adjustment on-board the standalone digital display device. The standalone digital display device dynamically adjusts the size of text, icons, and other GUI objects of presented GUI data based on the distance of the user's face detected before the standalone digital display device according to embodiments herein. The digital display device may include a video scaler hardware controller, a scaler memory device, and a power supply unit (PSU) to provide power to the video scaler hardware controller and scaler storage device. In an embodiment, the standalone digital display device may also include a visual sensor to capture images of a user's face. After capturing an image or images of the user's face, the video scaler hardware controller may execute computer-readable program code instructions of a facial detection module to detect facial patterns of a user's face based on the captured images of the user's face at the visual sensor according embodiments herein to identify a user's face before the standalone digital display device. In an embodiment, the video scaler hardware controller may also execute computer-readable program code of a facial sensing-to-distance data translator module to detect landmarks of the user's face within the facial patterns, detect the distance of the user's face relative to the digital display device based on the detected landmarks, and detect changes in distance of those facial features to generate delta displacement data as those changes occur. The video scaler hardware controller may also store the detected landmarks, the detected distance of the user's face relative to the digital display device, and the delta displacement data on the scaler memory device for future use. In an embodiment, the video scaler hardware controller executes computer-readable program code instructions of a distance data-to-user interface size module to translate the delta displacement data into a user interface size that adjusts the screen scale for text, icons and other GUI features based on the detected distance of the user's face relative to the digital display device. This automatic screen scale adjustment on-board the standalone digital display device may dynamically increase or decrease the size of the text, icons, and other GUI features presented on the digital display device based on the distance of the user's face relative to the standalone digital display device so that those text, icons, and other GUI features presented on the digital display device are made better identifiable and accessible to the user in a plurality of positions.

In an embodiment, the video scaler hardware controller may execute computer-readable program code instructions of a font setting application programming interface (API) to interface with user interface settings of the standalone digital display device to adjust the screen scale of text, icons or other GUI features based on the generated delta displacement data when translating the delta displacement data into a user interface size. Additionally, in an embodiment, the video scaler hardware controller to execute computer-readable program code instructions of a distance data-to-user interface size module to translate the delta displacement data into a user interface size for the GUI and its features including accessing user interface size look-up table to translate the user interface size. In an embodiment, the video scaler hardware controller may execute the computer-readable program code instructions of a distance data-to-user interface size module to translate the delta displacement data into a user interface size each time the delta displacement data is generated.

In an embodiment, the video scaler hardware controller may execute the computer-readable program code instructions of the facial detection module on-board the standalone digital display device to detect a single face among a plurality of faces of users in front of the visual sensor and select the single face of a single user among the plurality of faces of users before the standalone digital display device. This, single face identified may then be used to detect landmarks of the user's face within the facial patterns, detect the distance of the user's face relative to the standalone digital display device based on the detected landmarks, and detect changes in distance of those facial features to generate delta displacement data. Additionally, or alternatively, the video scaler hardware controller on-board the digital display device may execute the computer-readable program code instructions of the facial detection module to detect a centrally-located face among a plurality of faces of users in front of the visual sensor and select the centrally-located face to detect those landmarks of the user's face within the facial patterns, detect the distance of the user's face relative to the digital display device based on the detected landmarks, and detect changes in distance of those facial features to generate delta displacement data in embodiments herein.

The present system and method allows for automated and dynamic changes in the size of text, icons, and other GUI features presented on the standalone digital display device by a software application executing on an operatively coupled information handling system based on the distance of the user relative to the standalone digital display device. This automatic screen scale adjustment on-board the standalone digital display device allows the user more automatic convenience and flexibility in the position that the user would like to take in order to more comfortably view the standalone digital display device rather than requiring a cumbersome display settings adjustment during, for example, use of a GUI generated from a software application executing on an operatively coupled information handling system. This also improves the usability of the digital display device while reducing eye strain on the user.

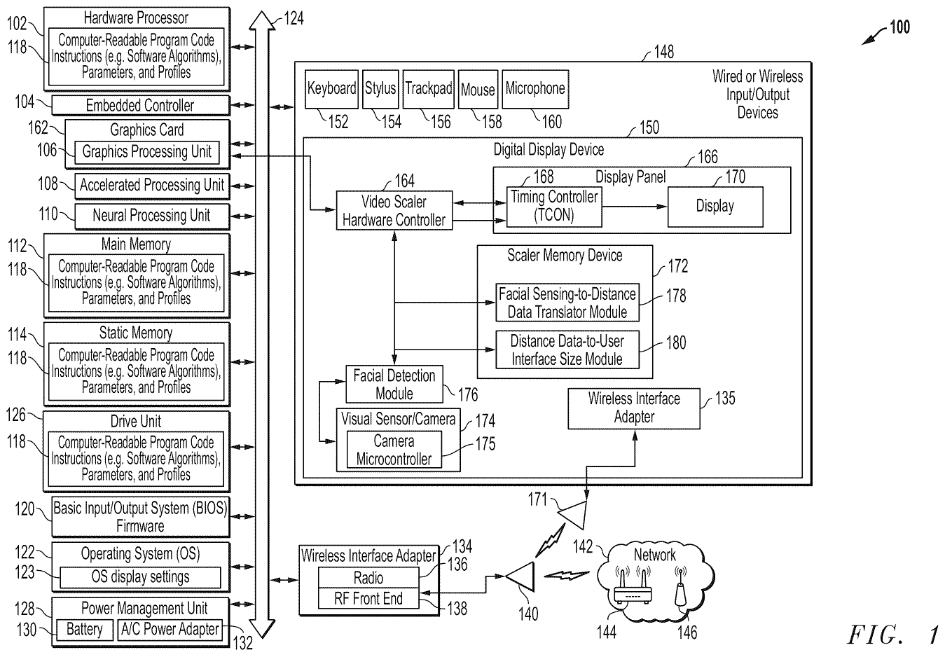

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a standalone digital display device 150, a microphone 160, or any combination thereof. The information handling system 100 may also have integrated I/O devices 148, not shown, such as an integrated keyboard, trackpad, web camera, microphone, and digital display device such as with a laptop or tablet information handling system 100. Such a laptop or tablet style information handling system 100 may still be used with a standalone digital display device 150 or other wired or wireless I/O devices 148 according to embodiments herein. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices. A standalone digital display device 150, according to embodiments of the present disclosure, may be operably coupled to information handling system via wired connectivity such as a USB connection or via a wireless link such as via wireless interface adapter 134.

As described in embodiments herein, the information handling system 100 further includes a digital display device and/or may be operatively coupled to a standalone digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external, standalone digital display device 150 that allows a user to increase the desktop area by extending the desktop according to embodiments herein. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device, including the standalone digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an access point (AP) 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in various embodiments herein, the information handling system 100 is operatively coupled to a standalone digital display device 150. The standalone digital display device 150 may be operatively coupled to the information handling system 100 via a wired connection such as a universal serial bus (USB) cable via a port such as a USB port formed into the information handling system 100. Additionally, or alternatively, the standalone digital display device 150 may be operatively coupled to the information handling system 100 via a wireless connection using the wireless interface adapter 134 and antenna 140 on information handling system 100 and wireless interface adapter 135 and antenna 171 onboard the standalone digital display device 150. Wireless communication may be via appropriate wireless protocols such as Bluetooth®, WLAN or others described herein.

In order to interface with the standalone digital display device 150 or any integrated digital display device, the information handling system 100 includes a GPU 106 formed on a graphics card 162 that transmits image, video, and GUI data to the standalone digital display device 150 or any integrated digital display device. The GPU 106 may be any hardware processing device that accelerates graphics rendering tasks such as rendering images, videos, and animations for representation on the display screen or display 170 of the standalone digital display device 150 or any integrated digital display device. It is appreciated, however, that any hardware processing device such as the hardware processor 102 (e.g., CPU), the EC 104, the APU 108, or the NPU 110 may also be used in tandem with or without the GPU 106 to render the images, videos, and animations for representation on the display 170, also referred to herein as a display screen 170.

The standalone digital display device 150 may include or be operatively coupled to a visual sensor 174. In the context of the present specification, the visual sensor 174 may be any device that can capture, at least, a portion of the user's face and provide output facial data that is used to recognize facial patterns and landmarks. In an embodiment, the visual sensor 174 may include a dedicated hardware processor or camera microcontroller 175 that can detect these facial patterns such as landmarks on the user's face and other facial patterns and provide this data as output to, for example, the facial detection module 176 and the video scaler hardware controller 164 on-board within the standalone digital display device 150. Alternatively, the visual sensor 174 may provide image output to the facial detection module 176 and video scaler hardware controller 164 to analyze and define facial landmarks, facial patterns, and other features of the user's face in order to detect the location of the user's face in front of the standalone digital display device 150 according to embodiments herein. In either example, at least a portion of the user's face is captured and analyzed to identify these facial patterns of a user's face before the standalone digital display device 150 by defining landmarks on the user's face. In an embodiment, the visual sensor 174 may be any type of time-of-flight (ToF) or visual sensor. In an embodiment, the visual sensor 174 may be an imaging device that can capture either or both a two-dimensional image or a three-dimensional image of the user's face. In an embodiment, the visual sensor 174 may be an RGB visual light camera that captures color images of the user's face, an infrared (IR) camera that captures depth and thermal information from the user's face, a ToF camera that measures the three-dimensional shape of the user's face, a light detection and ranging (LIDAR) that measures the three-dimensional shape of the user's face, and/or an ultrasonic sensor that measures the three-dimensional shape of the user's face. In an embodiment, the visual sensor 174 may implement one or a plurality of these technologies in order to capture one or more images of the user's face as the user moves within the frame of the visual sensor 174.

As the visual sensor 174, in real-time, captures the images of the user's face, the output from the visual sensor 174 is provided to a facial detection module 176. Again, the facial detection module 176 may be integral to the visual sensor 174 with a microcontroller or other hardware processor 175 of the visual sensor 174 executing the computer-readable program code instructions of the facial detection module 176 to detect facial patterns of a user's face based on those captured images of the user's face at the visual sensor 174. Again, in an alternative embodiment, the facial detection module 176 may be executed by the video scaler hardware controller 164 formed on, for example, a scaler board (not shown) within the standalone digital display device 150.

As the facial patterns of the user are detected, the video scaler hardware controller 164 may execute computer-readable program code instructions of a facial sensing-to-distance data translator module 178. Execution of the computer-readable program code instructions of the facial sensing-to-distance data translator module 178 may, in an embodiment, detect landmarks of the user's face within the facial patterns. These landmarks may include, for example, any points or features of the user's face such as position and shape of the user's eyes, distance between the user's eyes, specific points of the user's eyes such as the corner of the eyes, eyebrow shape, location, outer and inner corners of the user's eyebrows, relative angle to the user's eyes, location of the user's nose features such as the tip, bridge and nostrils, location of the user's mouth features such as the corners, center of lips, and upper and lower lip boundaries, locations and features of the user's chin, jawline, and cheekbones, location of the user's forehead, location of the user's ears, and the location of each of these features relative to each other. In embodiments herein, the identified facial features may be used to identify a face before the digital display device 150.

In an example embodiment, the facial recognition system uses these landmarks as anchor points for mapping the geometry and proportions of a face. In an embodiment, the scaler hardware controller 164 may execute algorithms such as a Histogram of Oriented Gradients (HOG) algorithms, Convolutional Neural Networks (CNNs) using, for example, a Maximum-Margin Object Detector (MMOD) for enhanced results, and Active Shape Model (ASM) algorithms that operate to extract and analyze these facial features. For instance, execution of a HOG algorithm works by extracting features into a vector and feeding those vectors into a classification algorithm like a Support Vector Machine (SVM), for example, that will assess whether a face (as trained) is present in a region or not. The facial features extracted, such as those facial features described above, are the distribution (e.g., histograms) of directions of gradients (e.g., oriented gradients) of the image. Because gradients are typically large around edges and corners, such as part of facial features above, this allows for those regions to be detected using the HOG algorithm. The HOG algorithm may be relatively computationally lightweight and well-suited for integration into the digital display device 150, enabling real-time facial analysis on the digital display device 150 with its own scaler hardware controller 164.

Alternatively, execution of a trained CNN using the MMOD algorithm may perform hierarchical feature extraction through multiple layers to recognize and match complex patterns with relatively higher accuracy. This execution of the trained CNN using the MMOD algorithm may be relatively more computationally robust requiring, in an embodiment, a hardware processor of the information handling system 100 to conduct or otherwise help in the processing of the images of the user's face, such as for user recognition, or a more robust scaler hardware controller 164 may be used. It is appreciated that any number of facial recognition algorithms may be executed, and the present specification contemplates the use of these other types of algorithms. In some embodiments, some portion of the facial features detected by execution of any facial recognition algorithm may be used, in an embodiment, to identify a specific user and may be saved in a scaler memory device 172 for later use and identification of a specific user during operation of the systems and methods described herein. Specific identification of a user, such as for authorization, may be conducted on the video scaler hardware controller 164 in some embodiments. However, in other embodiments, user identification using the capture image and facial features identified may require more processing and may be transmitted to an operatively coupled information handling system 100 for execution by a hardware processor 102, embedded controller 104, or GPU 106 located there in some embodiments.

The execution of the computer-readable program code instructions of the facial sensing-to-distance data translator module 178 on-board the video scalar hardware controller 164 also detects the distance of the user's face relative to the digital display device 150, upon identification of a user's face before the digital display device 150, based on the detected landmarks according to embodiments of the present disclosure. This distance of the user's face relative to the digital display device 150 may be calculated at the video scalar hardware controller 164 or at a microcontroller 175 of the video sensor/camera 174 using the focal length of visual sensor 174 and a detected height of the user's face at, for example, the CMOS sensor of the visual sensor 174. In an embodiment, the following set of equations may be used:

$$\frac{a}{f} = tan {θ}_{1} = \frac{h}{d} \qquad Eq . 1$$

$$\frac{b}{f} = tan {θ}_{2} = \frac{h}{d - m} \qquad Eq . 2$$

where a is the detected height of the user at the CMOS sensor of the visual sensor 174, f is the focal length of the visual sensor 174, b is the a change in height of the user at the CMOS of the visual sensor 174, d is the detected distance of the user relative to the digital display device 150 (and the visual sensor 174), and m is the actual change of distance of the user relative to the digital display device 150. Thus, Eq. 1 may be used to determine the current distance of the user relative to the digital display device 150 and Eq. 2 may be used to determine a change in the distance of the user relative to the digital display device 150. By dividing Eq. 1 with Eq. 2 the following equations reflect a simplification of the equations that may be used to determine a current and changing distance of the user relative to the digital display device 150:

$$\begin{matrix}\frac{a}{b} = \frac{h}{d} * \frac{d - m}{h} {\to }^{yields} \frac{a}{b} \\ = \frac{d - m}{d} \\ = 1 - \frac{m}{d} {\to }^{yields} \frac{m}{d} \\ = 1 - \frac{a}{b} {\to }^{yields} d \\ = \frac{m}{1 - \frac{a}{b}}\end{matrix} \qquad Eq . 3$$

This provides an equation that directly determines the distance “d” of the user relative to the digital display device 150 at any given time which includes a delta distance data that describes the change in distance of the user relative to the digital display device 150. This delta distance data representing a user's face displacement or change in location over time may also be saved on the scaler memory device 172 for later use by the systems and methods described herein. In an embodiment, this calculation may be completed by the facial sensing-to-distance data translator module 178 and may be done on a continuous or periodic (e.g., every 15 seconds) basis in an example embodiment. In an embodiment, this initial distance data and changes in the distance as delta distance data may be saved on the scaler memory device 172 as well for use by the video scaler hardware controller 164 as described herein.

As described herein, the digital display device 150 may include a video scaler hardware controller 164 that receives the image and video data output from the information handling system 100 as well as the detected landmarks of the user's face within the facial patterns, detected distance of the user's face relative to the digital display device 150 based on the detected landmarks, and detected changes in distance of those facial features of the user's face used to generate delta displacement data. The video scaler hardware controller 164 may be any hardware processing device that can receive the video output from the information handling system 100 and apply the detected landmarks of the user's face within the facial patterns, detected distance of the user's face relative to the digital display device 150 based on the detected landmarks, and detected changes in distance of those facial features of the user's face used to generate delta displacement data to adjust the size of the text, icons, and other GUI presented on the digital display device 150 according to the systems and methods described herein. In an embodiment, the video scaler hardware controller 164 may be formed onto a scaler board (not shown) installed within a standalone digital display device 150 that operatively couples the video scaler hardware controller 164 to a display panel 166.

During further operations, the video scaler hardware controller 164 may also execute computer-readable program code instructions for a distance data-to-user interface size module 180. The execution of the distance data-to-user interface size module 180 by the video scaler hardware controller 164 translates the delta displacement data into a user interface size that adjusts the screen scale automatically on-board of the standalone digital display device 150 based on the detected distance of the user's face relative to the digital display device 150. Such automatic screen scale adjustment on-board the standalone digital display device 150 may be in addition to or override any screen scale sizing for icons and other features of GUIs presented on the standalone digital display device 150 that may be set by settings at an operatively coupled information handling system 100. In some embodiments, this automatic screen scale adjustment on-board the standalone digital display device 150 may be optionally turned off by a user when the automatic scaling adjustments are not desired.

In an embodiment, the facial sensing-to-distance data translator module 178 may identify a distance of the user relative to the standalone digital display device 150 via implementation of the equations described herein and access a look-up table (LUT) that cross-references a plurality of distances to a pixel density or pixel per inch (ppi) value. The identified ppi may be provided to the video scaler hardware controller 164 to automatically alter the text, icons, and other GUI presented on the digital display device 150 to accommodate for changes in position of the user relative to the digital display device 150. It is appreciated that these text, icons, and other GUI features presented on the digital display device 150 may be generated by an executing software application on an operatively coupled information handling system 100. Such text, icons and other GUI features may be subject to user interface (UI) settings for the GUI at the operatively coupled information handling system 100 that affect their presentation on the standalone digital display device 150. However, manual adjustment of these settings via the operatively coupled information handlings system 100 upon adjustments to a user's position, and therefore distance of a user's face, so that the user can readily identify the text, icons, and other GUI presented on the digital display device 150 during operation may be cumbersome. It is further appreciated that the ppi value is not used by the video scaler hardware controller 164 to adjust the video output from the information handling system such as streaming data and other video data being presented to the user. Instead, this streaming or other video data received by the video scaler hardware controller 164 may be presented, as received from the operatively coupled information handling system 100, to the timing controller 168 on the display panel 166 for typical processing and presentation on the display device 170. Concurrently, however, those text, icons, and other GUI features presented on the standalone digital display device 150 by the execution of software applications at the operatively coupled information handling system 100 may be dynamically enlarged or reduced on-board the standalone digital display device based on the current location of the user's face relative to the standalone digital display device 150 according to execution of the embodiments and methods of the present disclosure.

In an embodiment, the visual sensor 174 on the standalone digital display device 150 may be capable of identifying a specific user among a plurality of users viewing the content presented on the standalone digital display device 150. For example, the visual sensor 174 may include a camera microcontroller 175 or other controller that is capable of identifying a user's face and facial features as well as execute to identify a specific user. The camera microcontroller 175 of visual sensor 174 in some embodiments may execute in coordination with other hardware processors, such as hardware processor 102 of the operatively coupled information handling system 100 or a video scaler hardware controller 164, to identify a specific user from a detected image of a user's face and facial features and associated with and identified by saved facial patterns such that the visual sensor 174 may also be used to engage in facial recognition processes and techniques to track or authorize a specific user within the frame of the visual sensor 174 and for operation with an operatively coupled information handling system 100. Additionally, the visual sensor 174 is used with various embodiments herein to identify that a user, or user's face, is within a specific portion of the frame of the visual sensor 174 such as a center location of the frame. This allows the visual sensor 174 to track the distance of that user who is positioned in a centrally-located area in front of the digital display device 150 regardless of who that user is identified as according to various embodiments herein.

The systems and methods described herein may automate the sizing and scaling of various text, icons, and other GUI features presented on the standalone digital display device 150 via execution on-board the standalone digital display device 150 of the facial sensing-to-distance data translator module 178 and the distance data-to-user interface size module 180 by the video scaler hardware controller 164 or other hardware processing resource on the standalone digital display device 150. Such execution automatically adjusts the size and scale of these text, icons, and other GUI features presented via the automatic screen scale adjustment on-board the standalone digital display device 150 to dynamically change the size and scale based on the distance of the detected user's face relative to the standalone digital display device 150. This automatic screen scale adjustment on-board the standalone digital display device 150 occurs for GUI presentation data in embodiments herein, but not for other display data such as streaming video data. The automatic screen scale adjustment on-board the standalone digital display device 150 of embodiments herein provides additional convenience to the user for GUI viewing as well as flexibility for the user's positioning in front of the standalone digital display device 150. This allows the user to relax in any position while viewing content on the digital display device 150 while still being able to view effectively view the text, icons, and other GUI features presented by the digital display device 150 without manually accessing settings, such as display settings, on the operatively coupled information handling system. This improves the usability of the standalone digital display device 150 while reducing the potential of eye strain on the user.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

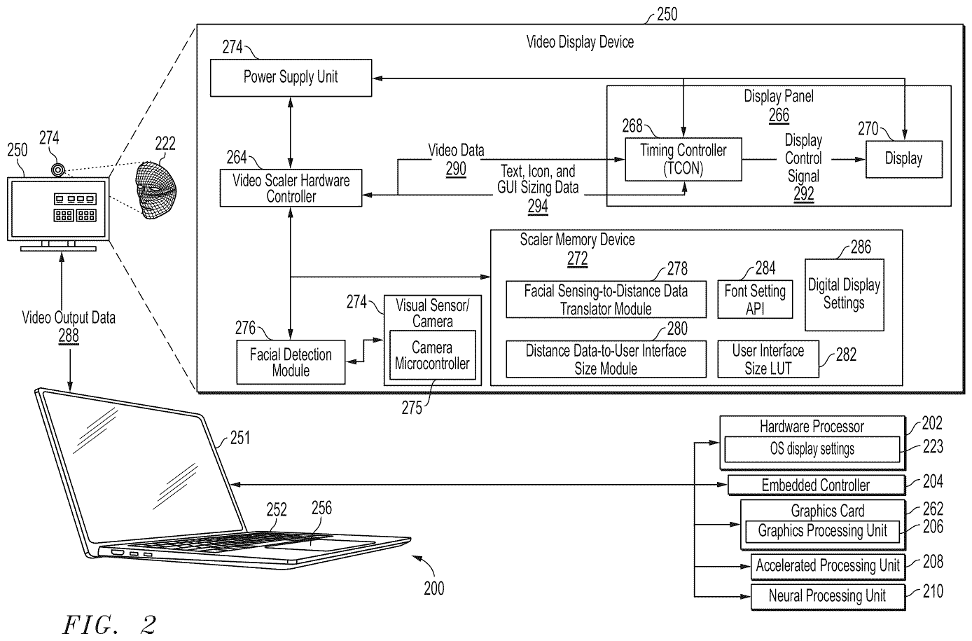

FIG. 2 is a graphic and block illustrating an information handling system 200 operatively coupled to a standalone digital display device 250 including a video scaler hardware controller 264 to on-board adjust a screen scale presented on the standalone digital display device 250 based on a detected distance of a user's face 222 relative to the standalone digital display device 250 according to another embodiment of the present disclosure. The information handling system 200 in FIG. 2 is shown as a laptop-type information handling system 200 according to some embodiments of the present specification. The information handling system 200 may include an integrated video display device 251 to provide output to the user as well as a keyboard 252, a touchpad 256, and other input devices for the user to provide input to the information handling system 200. The information handling system 200 may be operatively coupled to one or more external input/output devices (e.g., 148, FIG. 1) including a standalone digital display device 250 according to embodiments herein. The present specification contemplates that the standalone digital display device 250 may be a wired or wireless external, standalone digital display device 250. It is appreciated that other types of information handling systems may be used and the information handling system 200 presented in FIG. 2 is presented as an example of an information handling system 200 that can be used with the systems and methods described herein.

FIG. 2 also shows that the visual sensor 274 forms part of the standalone digital display device 250 and, in an embodiment, may be an internal part of the standalone digital display device 250 by being formed into the housing of the standalone digital display device 250. In another embodiment, the visual sensor 274 may be a separate input device that is operatively coupled to the standalone digital display device 250 via, for example, a universal serial bus (USB) port formed on the standalone digital display device 250. In this embodiment, the visual sensor 274 may be a webcam or other similar video or image capturing device.

As described herein, the information handling system 100 may be operatively coupled to the standalone digital display device 250 via a wired connection such as a universal serial bus (USB) cable via a port such as a USB port formed into the information handling system 200. However, the standalone digital display device 250 may be used as an additional display device in an example presented in FIG. 2 that shows a built-in digital display device 251 formed into the laptop-type information handling system 200. However, because the information handling system 200 may include desktop expansion capabilities a user may elect to use the standalone digital display devices 250 operatively coupled to the information handling system 200 that operate pursuant to the systems and methods described herein. Information handling system 200 may be a desktop, tablet or other type of information handling system in other embodiments.

In order to interface with the standalone digital display device 250 (or a plurality of standalone digital display devices 250 or integrated digital display device 251), the information handling system 200 includes a GPU 206 formed on a graphics card 262 that transmits video data for images, videos, and GUI data to the standalone digital display device 250. The GPU 206 may be any hardware processing device that accelerates graphics rendering tasks such as rendering images, videos, and animations for representation on the display screen or display 270 of the standalone digital display device 250 or of the integrated digital display device 251. It is appreciated, however, that any hardware processing device such as the hardware processor 202 (e.g., CPU), the EC 204, the APU 208, or the NPU 210 may also be used in tandem with or without the GPU 206 to render the images, videos, and animations for representation on the display 270, also referred to as a display screen 270 herein.

The standalone digital display device 250 may include or be operatively coupled to a visual sensor 274. In the context of the present specification, the visual sensor 274 may be any device that can capture, at least, a portion of the user's face and provide output facial data that is used to recognize facial patterns and landmarks. In an embodiment, the visual sensor 274 may include a dedicated hardware processor or microcontroller 275 that can detect these facial patterns such as landmarks on the user's face and other facial patterns and provide this data as output to, for example, the facial detection module 276 and the video scaler hardware controller 264 within the digital display device 250. Alternatively, the visual sensor 274 may provide image output to the facial detection module 276 executing on video scaler hardware controller 264 on board the standalone digital display device 250 to analyze and define facial landmarks, facial patterns, and other features of the user's face in order to detect the location of the user's face 222 in front of the standalone digital display device 250 and a distance of the user's face 222 from the standalone digital display device 250.

In either example, at least a portion of the user's face 222 is captured and analyzed to identify these facial patterns of the user's face 222 and define landmarks on the user's face 222. In an embodiment, the visual sensor 274 may be any type of ToF or visual sensor. In an embodiment, the visual sensor 274 may be an imaging device that can capture either or both a two-dimensional image or a three-dimensional image of the user's face 222. In an embodiment, the visual sensor 274 may be an RGB camera that captures color images of the user's face 222, an IR camera that captures depth and thermal information from the user's face 222, a ToF camera that measures the three-dimensional shape of the user's face 222, a LIDAR that measures the three-dimensional shape of the user's face 222, and/or an ultrasonic sensor that measures the three-dimensional shape of the user's face 222. In an embodiment, the visual sensor 274 may implement one or a plurality of these technologies in order to capture one or more images of the user's face 222 as the user moves within an image capture frame of the visual sensor 274.

As the visual sensor 274, in real-time, captures the images of the user's face 222, the output from the visual sensor 274 is provided to a facial detection module 276. Again, the facial detection module 276 may be integral to the visual sensor 274 and executed with a microcontroller or other hardware processor 275 of the visual sensor 274 executing the computer-readable program code instructions of the facial detection module 276 to detect facial patterns of a user's face 222 based on those captured images of the user's face 222 at the visual sensor 274. In an alternative embodiment, the facial detection module 276 may be code instructions executed by the video scaler hardware controller 264 formed on, for example, a scaler board (not shown) within the standalone digital display device 250.

In an example embodiment, the facial recognition system of the facial detection module 276 executes to use these landmark for facial features as anchor points for mapping the geometry and proportions of a face. In an embodiment, the scaler hardware controller 264 may execute algorithms such as a Histogram of Oriented Gradients (HOG) algorithms, Convolutional Neural Networks (CNNs) using, for example, a Maximum-Margin Object Detector (MMOD) for enhanced results, and Active Shape Model (ASM) algorithms that operate to extract and analyze these facial features from images capture of the user's face 222 by the visual sensor or camera 274. For instance, execution of a HOG algorithm works by extracting features into a vector and feeding those vectors into a classification algorithm like a Support Vector Machine (SVM), for example, that will assess whether a face (as trained) is present in a region or not. The facial features extracted, such as those facial features described above, are the distribution (e.g., histograms) of directions of gradients (e.g., oriented gradients) of the image. Because gradients are typically large around edges and corners, such as part of facial features above, this allows for those regions to be detected using the HOG algorithm. The HOG algorithm may be relatively computationally lightweight and well-suited for integration into the standalone digital display device 250, enabling real-time facial analysis on the standalone digital display device 250 with its own scaler hardware controller 264. Alternatively, execution of a trained CNN using the MMOD algorithm may perform hierarchical feature extraction through multiple layers to recognize and match complex patterns with relatively higher accuracy via the scaler hardware controller 264 that is more robust or an additional hardware processing resource on the standalone digital display device 250. This execution of the trained CNN using the MMOD algorithm may be relatively more computationally robust requiring, in an embodiment, more processing resources at the standalone digital display device. It is appreciated that any number of facial recognition algorithms may be stored on the scaler memory device 272 and executed by the scaler hardware controller 264, the camera microcontroller 275, some combination, or other hardware processing resources at the standalone digital display device 250, and the present specification contemplates the use of these and other types of facial detection algorithms.

In some embodiments, the hardware processor of the information handling system 100 may also receive image and facial features capture of a user's face 222 to conduct or otherwise help in the processing of the images of the user's face, such as for user recognition. In some embodiments, some portion of the facial features detected by execution of any facial recognition algorithm may be used, in an embodiment, to identify a specific user and may be saved in a scaler memory device 272 for later use and identification of a specific user during operation of the systems and methods described herein. Specific identification of a user, such as for authorization, may be conducted on the video scaler hardware controller 164 in some embodiments. However, in other embodiments, user identification using the captured image and facial features of a user's face 222 identified may require more processing and may be transmitted to an operatively coupled information handling system 200 for execution by a hardware processor 202, embedded controller 204, or GPU 206 located there in some embodiments.

As the facial patterns of the user are detected, the video scaler hardware controller 264 may execute computer-readable program code instructions of a facial sensing-to-distance data translator module 278 stored at the scaler memory device 272. Execution of the computer-readable program code instructions of the facial sensing-to-distance data translator module 278 may, in an embodiment, detect landmarks of the user's face within the facial patterns. These landmarks may include any number of points or features of the user's face as described herein as well as each point or features' location relative to each other. Each of these points or features may be used, in an embodiment, to identify a user's face 222 before the standalone digital display device 250 to determine a distance of the user's face 222 from the standalone digital display device 250 use during operation of the systems and methods for automatic screen scale adjustment on-board the standalone digital display device 250 of identified GUI-type video data described in embodiments herein.

The execution of the computer-readable program code instructions of the facial sensing-to-distance data translator module 278 detects the distance of the user's face 222 relative to the standalone digital display device 250 based on the detected landmarks identified with one or more facial detection algorithms described herein. This distance of the user's face 222 relative to the digital display device 250 may be calculated using the focal length of visual sensor 274 and a detected height of the user's face 222 at, for example, the CMOS sensor of the visual sensor 274. In an embodiment, those equations described herein (Eq. 1, Eq. 2, and/or Eq. 3) may be used to complete these calculations and identify the distance of one or more facial features of a user's face 222 from the standalone digital display device 250 using the captured image of that user's face 222.

Again, execution of code instructions of the facial sensing-to-distance data translator module 278 may utilize inputs of a known height of the CMOS sensor of the visual sensor 274, a focal length of the visual sensor 274, and a location of a facial feature of the user's face 222 as inputs to Eq. 1 to determine the current distance of the user's face 222 relative to the digital display device 250. Execution of code instructions of the facial sensing-to-distance data translator module 278 by the video scaler hardware controller 264 may user Eq. 2 to determine any changes in the baseline distance of the user relative to the standalone digital display device 250 for monitoring such that Eq. 3 described herein also provides an equation that directly determines the distance “d” of the user relative to the standalone digital display device 250 at any given time to include a delta distance data that describes the change in distance of the user relative to the standalone digital display device 250 upon monitoring for changes in distance requiring automatic adjustment of screen scale at the display screen 270 of the standalone digital display device 250. This delta displacement data may also be saved on the scaler memory device 272 for later use by the systems and methods described herein.

In an embodiment, execution of the facial sensing-to-distance data translator module 278 to determine distance or delta distance data may be done on a continuous or periodic (e.g., every 10 or 15 seconds) basis in an example embodiment and may determine if a threshold change in distance of the user's face 222 from the standalone digital display device 250 has occurred to trigger additional automatic screen scale adjustment on-board the standalone digital display device 250 of the identified GUI-type video data. In an embodiment, this distance data and the detected changes in the distance data may be saved on the scaler memory device 272 as well for use by the video scaler hardware controller 264 as a new baseline or current distance as described herein. Threshold distance changes amounts may be any level and may include a threshold distance change amount of 20 cm, 25 cm, 50 cm, or the like to trigger automatic screen scale adjustment on-board the standalone digital display device 250 of identified GUI-type video data in example embodiments.

As described herein, the digital display device 250 may include the video scaler hardware controller 264 that receives the video output data 288 or video data 288 from the information handling system 200. Such video data 288 may be identified by type of video data 288 to indicate a GUI-type video data or other type of video data. For example, a streaming video data type may not trigger execution of code instructions to conduct the automatic screen scale adjustment on-board the standalone digital display device 250 as that would be distracting. However, GUI-type video data received as video data 288 may be welcomed for execution of code instructions to conduct automatic screen scale adjustment on-board the standalone digital display device 250 of the identified GUI-type video data. The video scaler hardware controller 264 may execute to receive metadata or other identification of the video data type in video data 288 received from the operatively coupled information handling system 200. In other embodiments, the video scaler hardware controller 264 may determine if GUI type data is received at 288 from the type of video data 288 received, for example GUI-type data may be bursty data whereas video streaming data may not be bursty but instead streaming and consistent with higher throughput requirements.

The video scaler hardware controller 264 may also receive the detected landmarks of the user's face 222 within the facial patterns to identify a user's face 222 before the standalone digital display device 250. The video scaler hardware controller 264 or other hardware resource may execute code instructions for the facial sensing-to-distance data translator module 278 to determine detected distance of the user's face 222 relative to the standalone digital display device 250 based on the detected landmarks, and detected changes in distance of those facial features of the user's face 222 to generate delta displacement data described herein for monitoring distance of a user's face 222 from the standalone digital display device 250. The video scaler hardware controller 264, operating as a hardware processing device within the standalone digital display device 250, may receive the video output data 288 from the information handling system 200 and provide the video data 290, with any scaling adjustment pursuant to embodiments herein, to the TCON 268 for processing and display at the display screen 270 as described herein. This video data 290 presented to the TCON 268 is processed by the TCON 268 and transmitted to the display screen 270 as part of the display control signal 292.

Concurrently, as described herein, the video scaler hardware controller 264 may execute the code instructions of the distance data-to-user interface size module to take the detected landmarks of the user's face 222 within the facial patterns, detected distance of the user's face 222 relative to the digital display device 250 based on the detected landmarks, and detected changes in distance of those facial features of the user's face 222 used to generate delta displacement data in order to adjust the size of the text, icons, and other GUI features presented on the digital display device 250 according to the systems and methods described herein. This data is also transmitted to the TCON 268 as text, icon, and GUI sizing data 294 which, in turn, is used as part of the display control signal 292 to control size and adjustments to GUI-type data for text, icons, or GUI features presented to the display screen 270. In an embodiment, the video scaler hardware controller 264 may be formed onto a scaler board (not shown) that operatively couples the video scaler hardware controller 264 to a display panel 266.

During further operations, the video scaler hardware controller 264 may also execute computer-readable program code instructions for a distance data-to-user interface size module 280 for automatic screen scale adjustment on-board the standalone digital display device 250 of identified GUI-type video data with changes to location of a user's face 222. The execution of the distance data-to-user interface size module 280 by the video scaler hardware controller 264 translates the delta displacement data, or detected distances of a user's face 222, into a user interface size that adjusts the screen scale based on the detected distance of the user's face 222 relative to the digital display device 250. In an embodiment, the facial sensing-to-distance data translator module 278 may identify a distance of the user relative to the digital display device 250 via implementation of the equations described herein for the distance is detected and access a user interface size LUT 282 that cross-references a plurality of distances to a pixel density or pixel per inch (ppi) value. The identified ppi may be provided to the video scaler hardware controller 264 to alter the text, icons, and other GUI features presented on the digital display device 250 to accommodate for changes in position of the user distance relative to the standalone digital display device 250. It is appreciated that these text, icons, and other GUI features presented on the digital display device 250 may be generated for graphical user interface (GUI) type video data and may be subject to OS GUI settings in some embodiments. Thus, the automatic screen scale adjustment on-board the standalone digital display device 250 of identified GUI-type video data is conducted pursuant to the execution of the distance data-to-user interface size module 280 by the video scaler hardware controller 264. This automatic screen scale adjustment on-board the standalone digital display device 250 of identified GUI-type video data enables the user to readily read and identify the text, icons, and other GUI features presented on the standalone digital display device 250 during operation regardless of the distance of the user's face 222 from the standalone digital display device 250. Concurrently, those text, icons, and other GUI features presented on the standalone digital display device 250 by GUI-type video data, and pursuant to any OS UI settings, may be dynamically enlarged or reduced based on the current location or distance of the user's face 222 relative to the standalone digital display device 250 based on a delta distance value detected for a change in position of the user's face 222 by greater than a threshold delta distance or distance difference amount in embodiments herein. Thus, changes in distance of the user's face 222 from the standalone digital display device 250 may be monitored by the visual sensor or camera 274 and execution of the facial detection module 276 in connection with the facial sensing-to-distance data translator module by the video scaler hardware controller 264 on-board of the standalone digital display device 250.

It is further appreciated that the ppi value is not used by the video scaler hardware controller 264 to adjust the video output data 288, also referred to as video data 288, received from the information handling system 200 when received video data 288 is determined to be streaming data such as streaming video data being presented to the user. Instead, this streaming or other video output data 288 received by the video scaler hardware controller 264 may be presented to the timing controller 268 on the display panel 266 for typical processing and presentation on the display screen 270 at a default scale level specified by the executing software application or OS settings at the operatively coupled information handling system 200.

During operation, the video scaler hardware controller 264 may execute computer-readable program code instructions of a font setting API 284 in connection with the determination of ppi scaling of automatic screen scale adjustment on-board the standalone digital display device 250 for identified GUI-type video data by the distance data-to-user interface size module 280 according to embodiments herein. Execution of the computer-readable program code instructions of the font setting API 284 allows the video scaler hardware controller 264 to interface with display settings of the standalone digital display device 250 in order to adjust the screen scale based on the generated delta displacement data and associated changes to ppi values when translating the delta displacement data into a user interface size. Thus, the font setting API 284 allows the video scaler hardware controller 264 to apply the appropriate ppi scaling to the text, icons, and other GUI features presented on the digital display device 250 for automatic screen scale adjustment on-board the standalone digital display device 250 to identified GUI-type video data. In an embodiment, the video scaler hardware controller 264 is allowed to access the digital display settings 286 in order to override any current size settings such as received from OS display settings from an operatively coupled information handling system 200 and applied to GUI-type video data for the text, icons, and other GUI features to be presented on the standalone digital display device 250. Accordingly, the systems and methods described herein may dynamically adjust the size of those text, icons, and other GUI features presented on the digital display device 250 dynamically according to changes in the distance detected of the user's face 222 relative to the standalone digital display device 250. Such changed distances may be subject to reaching a threshold distance change level in various embodiments. Example threshold distance change levels may be any value, but may include a threshold of 10 cm, 15 cm, 20 cm, 25 cm, 30 cm, or other distances so that automatic screen scale adjustment on-board the standalone digital display device 250 for identified GUI-type video data does not occur too frequently or is too sensitive.

In an embodiment, the visual sensor 274 may be capable of identifying a specific user among a plurality of users viewing the content presented on the digital display device 250 during operations. For example, the visual sensor 274 may be capable of identifying a specific user associated with and identified by saved facial patterns such that the visual sensor 274 also engages in facial recognition processes and techniques to track that specific, designated user within the frame of the visual sensor 274. Such tracking and identification of a specific designated user's face 222 among a plurality of potential user faces, such as in a background, may enable automatic screen scale adjustment on-board the standalone digital display device 250 for identified GUI-type video data only for the specific, designated user's face 222. Additionally, or alternatively, the visual sensor 274 may identify a user within a specific portion of the frame of the visual sensor 274 such as a center location of the frame. This allows the visual sensor 274 to track the distance of any user who is positioned in a centrally-located area in front of the standalone digital display device 250 for automatic screen scale adjustment on-board the standalone digital display device 250 for identified GUI-type video data regardless of who is identified as that user as long as the user is centrally-located in the image capture frame of the visual sensor 274.

The systems and methods described herein may automate the sizing and scaling of various text, icons, and other GUI features presented on the digital display device 250 by the digital display device 250 so that the size and scale of these text, icons, and other GUI features presented may be dynamically changed based on the distance of the detected user's face 222 relative to the standalone digital display device 250. This provides additional convenience to the user as well as flexibility in the user's positioning in front of the standalone digital display device 250. This allows the user to relax in any position while viewing GUI based content on the digital display device 250 for automatic screen scale adjustment on-board the standalone digital display device 250 to enable easy viewing of the text, icons, and other GUI features presented by the standalone digital display device 250 without needing to manually access and adjust OS settings for the display at the operatively coupled information handling system 200. This improves the usability and comfortability of the standalone digital display device 250 while reducing the potential of eye strain on the user.

FIG. 2 further shows a power supply unit (PSU) 274 within the standalone digital display device 250. As described herein, the standalone video display device 250 may be powered via a PMU within the information handling system 200 via a power/data cable operatively coupling the information handling system 200 to the standalone video display device 250. Alternatively, where the standalone video display device 250 is a wireless video display device 250, the standalone video display device 250 may be powered using a power cable operatively coupling an A/C power source to the PSU 274 within the standalone video display device 250. The PSU 274 may operate similarly to the PMU described in connection with the information handling system 200 by regulating power from the A/C power source to each of the components of the standalone video display device 250 such as the video scaler hardware controller 264, the TCON 268, scaler memory device 272, and the display screen 270 as well as other components of the standalone digital display device 250 described herein.

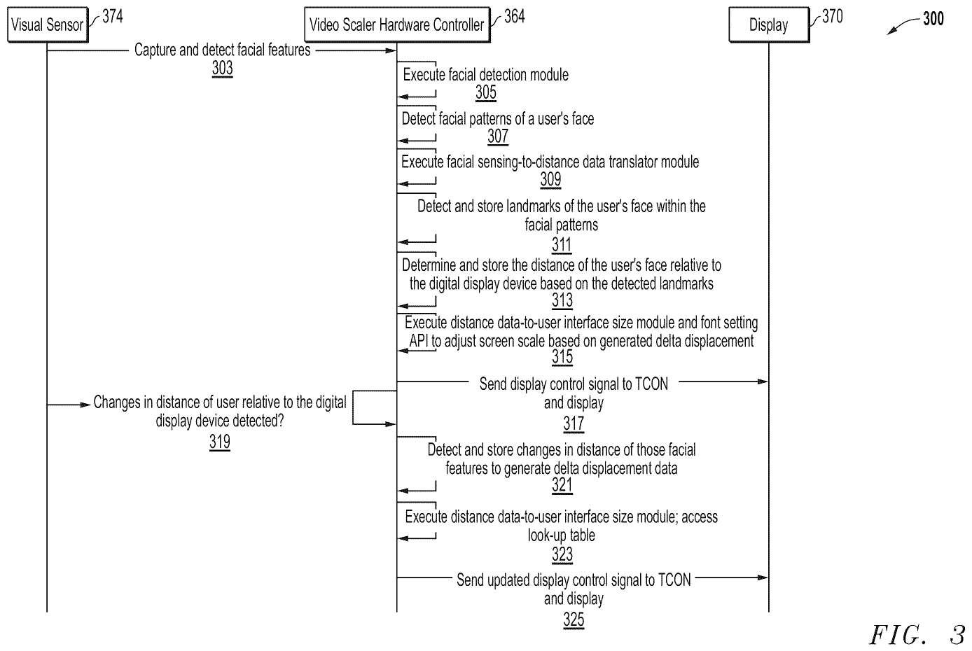

FIG. 3 is a flow diagram showing a method 300 of executing computer-readable program code instructions for automatic screen scale adjustment on-board a standalone digital display device for identified GUI-type video data according to an embodiment of the present disclosure. This method 300 may be implemented on one or more of the digital display devices described in connection with FIGS. 1 and 2.

The method 300 may include, at line 303, with the visual sensor 374 capturing and detecting facial features. As shown in FIG. 3, in an example embodiment, the visual sensor 374 may include a dedicated hardware processor or microcontroller that can detect these facial patterns such as landmarks on the user's face and other facial patterns and provide this data as output to, for example, a facial detection module and the video scaler hardware controller 164 within the standalone digital display device.

At line 305, the video scaler hardware controller may execute computer-readable code instructions of a facial detection module. As described in some embodiments herein, the visual sensor may include a dedicated hardware processor or microcontroller that can detect these facial patterns such as landmarks on the user's face and other facial patterns according to one or more facial recognitions algorithms according to embodiments herein. Data for this captured image of a user's face and facial feature identification may be provided from the facial detection module, for example, to the video scaler hardware controller 364 within the standalone digital display device. In an embodiment at line 305, the video scaler hardware controller 364 may execute code instructions of the facial detection module. Alternatively, the dedicated hardware processor or camera microcontroller of a visual sensor execute the facial detection module and then may provide image output from the facial detection module to video scaler hardware controller to analyze and define facial landmarks, facial patterns, and other features of the user's face or to determine distance for the location of the user's face in front of the standalone digital display device.

At line 307, the method 300 includes detecting those facial patterns and facial features of the user's face. This may include identifying any landmarks of the user's face in an embodiment. These landmarks may include, for example, any points or features of the user's face such as position and shape of the user's eyes, distance between the user's eyes, specific points of the user's eyes such as the corner of the eyes, eyebrow shape, location, outer and inner corners of the user's eyebrows, relative angle to the user's eyes, location of the user's nose features such as the tip, bridge and nostrils, location of the user's mouth features such as the corners, center of lips, and upper and lower lip boundaries, locations and features of the user's chin, jawline, and cheekbones, location of the user's forehead, location of the user's ears, and the location of each of these features relative to each other. As described, facial recognition algorithms described in embodiments herein may identify edges or features of the image of a user's face before the standalone digital display device. Each or any of these features may be used, in an embodiment, to identify a distance of a user's face in front of the standalone digital display device. In some embodiments herein, the image of a user's face including identified facial features and relative location of those features on the face may be used to identify a specific user for authorization or security purposes and stored in a scaler memory device for later use and identification of a specific user during operation of the systems and methods described herein.

The method 300 includes, at line 309, the video scaler hardware controller 364 executing computer-readable program code instructions of the facial sensing-to-distance data translator module. The execution of the computer-readable program code instructions of the facial sensing-to-distance data translator module detects the distance of the user's face, such as using one or more of the identified facial features or landmarks, relative to the standalone digital display device. This distance of the user's face relative to the standalone digital display device may be calculated using the focal length of visual sensor and a detected height of the user's face at, for example, the CMOS sensor of the visual sensor. In some embodiments, execution of code instructions of the facial sensing-to-distance data translator module may include input of those values and relative locations of the facial features into those equations, such as Eq. 1, Eq. 2, and/or Eq. 3 above, to determine a distance between a facial feature of a user's face and the standalone digital display device.

At line 311, the method 300 also includes detecting and storing landmarks of the user's face within the facial patterns. As described herein, the digital display device includes a scaler memory device used to store this data for later use by the video scaler hardware controller for ongoing monitoring of distance changes of a user's face relative to the standalone digital display device or for user identification in some embodiments. The scaler memory device may be operatively coupled to the video scaler hardware controller and may be formed onto a scalar board in some embodiments.

The method 300 further includes, at line 313, detecting and storing data describing the distance of the user's face relative to the standalone digital display device based on the detected facial features or landmarks of the detected image of the user's face. Execution of the computer-readable program code instructions of the facial sensing-to-distance data module by the video scaler hardware controller 364 causes this distance data to be generated. In an example embodiment, input of dimensions for height of a image capture device, the identified location of one or more landmarks or facial features of a user's face, and a focal point of the visual sensor 374 or a time-of-flight distance estimation to one or more landmarks or facial features may be input into Eq. 1 to determine the current distance of the user relative to the standalone digital display device and Eq. 2 may be used to determine ongoing changes in the distance of the user relative to the standalone digital display device. Eq. 3 described herein also provides an equation that directly determines the distance “d” of the user relative to the standalone digital display device at any given time which includes calculation of a delta distance data that describes the change in distance of the user relative to the digital display device when the user moves and changes occur to the dimensions of or locations of facial landmarks or facial features in facial images capture of the user. This delta distance data indicating distance change amounts may also be saved on the scaler memory device for later use by the systems and methods described herein during ongoing monitoring of the distance of a user's face from the standalone digital display device. In an embodiment, execution of code instructions of the facial sensing-to-distance data module by the video scaler hardware controller 364 may be completed on a continuous or periodic (e.g., every 10 or 15 seconds) basis in an example embodiment. In an embodiment, this distance data and changes in the distance data may be saved on the scaler memory device as well for use by the video scaler hardware controller as described herein.

At line 315, the video scaler hardware controller may execute the computer-readable program code instructions of the distance data-to-user interface size module and execute a font setting API to adjust screen scale based on the generated delta displacement data determined for a detected user's face from the visual sensor 374. Execution of the computer-readable program code instructions of the font setting API allows the video scaler hardware controller to interface with user interface settings of the standalone digital display device in order to adjust the screen scale based on the generated delta displacement data when translating the delta displacement data into a user interface size. Thus, the distance data-to-user interface size module executed by the video scaler hardware controller determines an appropriate ppi scaling to the text, icons, and other GUI features presented on the digital display device. In an embodiment, the video scaler hardware controller is allowed to access the video and graphics display settings with the font settings API in order to override any current size settings associated with the text, icons, and other GUI features from executing software applications or OS display settings from an operatively coupled information handling system. With the determined distance of a detected user's face from a standalone digital display device from an image captured by the visual sensor 374, the systems and methods described herein may dynamically adjust the size of those text, icons, and other GUI features presented on the digital display device as the distance of the user's face relative to the digital display device changes. Thus, at line 317, the display control signal that comprises the dynamic adjustments of the text, icons, and other GUI features are sent to the TCON and the display for visual presentation to the user.

At line 319, the method 300 also includes the periodic determination whether changes in the distance of the user's face relative to the digital display device has been detected. Where no changes have been detected, the present method may end here. However, because this calculation is made on a continuous or periodic (e.g., every 10 or 15 seconds) basis, a change in the distance of the user's face relative to the digital display device may trigger a change in the size or scale of the text, icons, and other GUI presented on the digital display device. Thus, where a change in distance is detected, the method 300 continues to line 321.

At line 321, the method 300 includes detecting and storing the changes in distance of those facial features being tracked in order to generate the delta displacement data described herein. Proceeding to line 323, the execution of the computer-readable program code instructions of the distance data-to-user interface size module by the video scaler hardware controller translates the delta displacement data into a user interface size, with a ppi value for text, icons and other GUI features, that adjusts the screen scale based on the detected distance of the user's face relative to the standalone digital display device. In an embodiment, the facial sensing-to-distance data translator module may receive additional images of a user from the visual sensor 374 and, with similar facial features or landmarks, identify a distance of the user relative to the digital display device. The video scaler hardware controller 364 executes the computer readable code instructions of the facial sensing-to-distance data translator module to implementation one or more the equations or calculations described herein to determine a distance of delta distance value of the user's face at a current point in time from the standalone digital display device. With this distance value or delta distance value relative to a previously recorded distance value for the user's face, the distance data-to-user interface size module accesses a LUT at line 323 in some embodiments that cross-references a plurality of distances to a pixel density or ppi values to be applied to GUI-type video data received from an operatively coupled information handling system. The identified ppi may be provided to the video scaler hardware controller to alter the text, icons, and other GUI features from the GUI-type video data received and to be presented on the standalone digital display device to accommodate for changes in position of the user relative to the standalone digital display device. It is appreciated that these text, icons, and other GUI features presented on the standalone digital display device may be generated via execution of software applications and rendering by a graphics processor, such as a GPU, at the operatively coupled information handling system and transmitted along with any OS display settings for the video data to the standalone digital display device.

The ppi values or pixel density adjustments to the GUI-type video data received from the operatively coupled information handling systema may override existing scaling settings for the GUI-type video data and may be periodically adjusted so that the user can readily identify the text, icons, and other GUI features presented on the digital display device during operation. For example, assessment of changes to the user face location in images of the user's face captured by the visual sensor 374 may occur periodically, such as every 15 seconds or during a different period. Moreover, a user distance change threshold amount may need to be reached before dynamic or automatic adjustment of ppi values or pixel density adjustments to the GUI-type video data is applied to avoid over sensitivity or too-frequent adjustment. For example, a distance change threshold of 10 cm, 15 cm, 20 cm, 25 cm or another threshold may need to be met before the execution of the distance data-to-user interface size module by the video scaler hardware controller dynamically adjusts the ppi values or pixel density adjustments to the GUI-type video data received. It is further appreciated that the ppi value is not used by the video scaler hardware controller to adjust the video output, such as video data that is streaming video, from the information handling system including various types of streaming data or streaming video data being presented to the user. Instead, this streaming or other video data received by the video scaler hardware controller may be presented to the timing controller on the display panel for typical processing and presentation on the display device as set by the execution of the software application executing or the OS display settings from the operatively coupled information handling system without changes by the distance data-to-user interface size module by the video scaler hardware controller.

Thus, those text, icons, and other GUI features presented on the standalone digital display device by the distance data-to-user interface size module executed on-board by the video scaler hardware controller may be dynamically enlarged or reduced in received GUI-type video data based on the current location or detected distance of the user's face relative to the standalone digital display device. Thus, at line 325, the method 300 also includes sending this updated display control signal with the updated sizing or scaling of the text, icons, and other GUI features as determined by the distance data-to-user interface size module executed by the video scaler hardware controller to the TCON for display on the display 370 of the standalone digital display device at an updated scale to the user that is appropriate for the detected distance of the user from the standalone digital display device. It is appreciated that those processes described in connection with lines 319 through 325 may be repeated any time the video scaler hardware controller detects changes in the distance of the user relative to the digital display device (e.g., detects delta distance data) until power to the digital display device has been turned off.

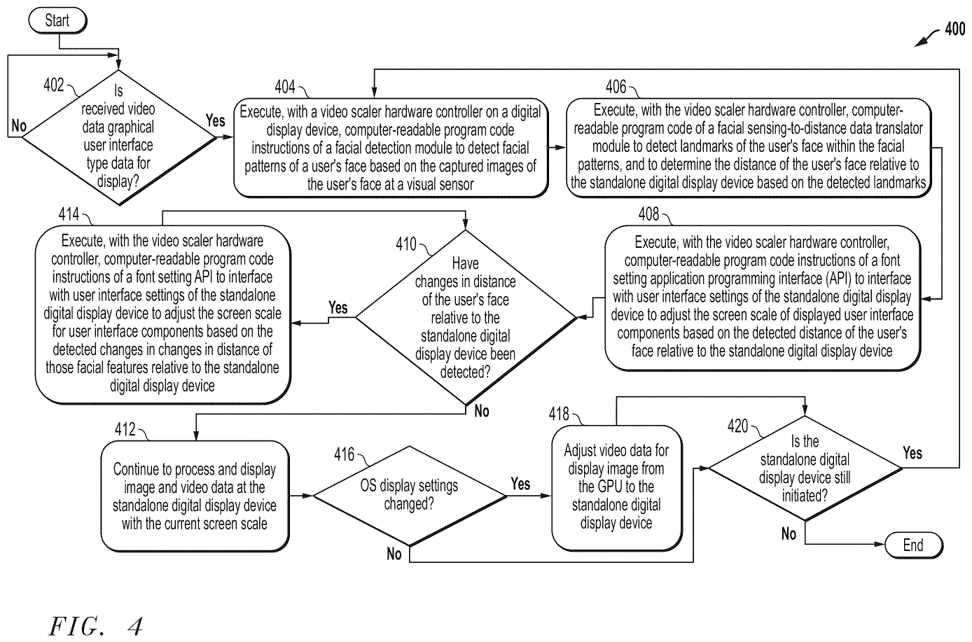

FIG. 4 is a flow diagram showing a method of executing computer-readable program code instructions on-board a digital display device for adjusting a screen scale of a user interface based on detected distance of a user in addition to manual operating system display adjustments according to another embodiment of the present disclosure. The method 400 described in connection with FIG. 4 may be automatically operated on-board of a digital display device (e.g., 150, 250) operatively coupled to an information handling system such as an information handling system (e.g., 100, 200) described in connection with FIG. 1 or 2.

Method 400 begins at block 402 in an example embodiment, where the operatively coupled information handling system, such as from a GPU or other graphics hardware processor, sends video data to a standalone digital display device via a wired or wireless connection. The video scaler controller on-board the standalone digital display device may receive the video data. In some embodiments, the GPU or other graphics hardware processor may send metadata or a command indicating a type of video data being sent to identify if video data is sent for a graphical user interface type of video data or another type of video data such as streaming video data. In other embodiments, the video scaler controller on-board the standalone digital display device may determine whether the received video data is streaming video data or bursty type video data such as for a GUI for presentation on the display. In either embodiment, video scaler controller on-board the standalone digital display device executing computer readable code instructions to determine whether a GUI-type video data has been received to trigger execution of a facial detection module at a visual sensor microcontroller or at the video scaler controller on-board the standalone digital display device and to trigger the processes of a facial sensing-to-distance data module and distance data-to-user interface size module. If the received video data is determined to be GUI-type video data at block 402, then the method proceeds to block 404 to initiate code instructions for automatic screen scale adjustment on-board the standalone digital display device to dynamically adjust the sizing and scaling of various text, icons, and other GUI features presented on the standalone digital display device based on distance of the user from the standalone digital display device. If the video data received is determined to not be GUI-type video data or is determined to be streaming video data, the method returns to block 402 to monitor for when GUI-type video data is being received.

At block 404, the method 400 includes executing, with a video scaler hardware controller on-board a standalone digital display device, computer-readable program code instructions of a facial detection module to detect facial patterns of a user's face based on the captured images of the user's face at a visual sensor embedded or operatively coupled to the digital display device. As described herein, a visual sensor may be used to capture, at least, a portion of a user's face detected within the frame of the visual sensor. As the visual sensor, in real-time, captures the images of the user's face, the output from the visual sensor is provided to a facial detection module executing at a video scalar hardware controller or other hardware processor at the digital display device or the visual sensor device. In example embodiments, the visual sensor device may be a web camera, a camera, an infrared camera, a lidar system, or other visual sensor device for at least partially detecting a user's face before a digital display device. Again, the facial detection module may be executed on a hardware processor or hardware controller integral to the visual sensor device, such as with a microcontroller or other hardware processor of a camera system that is the visual sensor device of the digital display device. In other embodiments, the facial detection module may be executed on a hardware processor or hardware controller, such as a video scalar hardware microcontroller, of the digital display device. The on-board hardware processor or hardware controller for the digital display device or visual sensor device executes the computer-readable program code instructions of the facial detection module to detect facial patterns of a user's face based on those captured images of the user's face before the digital display device by the visual sensor. Again, in an alternative embodiment, the facial detection module may be executed by the video scaler hardware controller formed on, for example, a scaler board within the digital display device.

In an embodiment, the scaler hardware controller may execute algorithms such as a Histogram of Oriented Gradients (HOG) algorithms, Convolutional Neural Networks (CNNs) using, for example, a Maximum-Margin Object Detector (MMOD) for enhanced results, and Active Shape Model (ASM) algorithms that operate to extract and analyze these facial features. For instance, execution of a HOG algorithm works by extracting features into a vector and feeding those vectors into a classification algorithm like a Support Vector Machine (SVM), for example, that will assess whether a face (as trained) is present in a region or not. The facial features extracted, such as those facial features described above, are the distribution (e.g., histograms) of directions of gradients (e.g., oriented gradients) of the image. Because gradients are typically large around edges and corners, such as part of facial features above, this allows for those regions to be detected using the HOG algorithm. The HOG algorithm may be relatively computationally lightweight and well-suited for integration into the digital display device, enabling real-time facial analysis on the digital display device with its own scaler hardware controller.

Alternatively, execution of a trained CNN using the MMOD algorithm may perform hierarchical feature extraction through multiple layers to recognize and match complex patterns with relatively higher accuracy. This execution of the trained CNN using the MMOD algorithm may be relatively more computationally robust requiring, in an embodiment, a hardware processor of the information handling system to conduct or otherwise help in the processing of the images of the user's face, such as for user recognition, or a more robust scaler hardware controller may be used. It is appreciated that any number of facial recognition algorithms may be executed, and the present specification contemplates the use of these other types of algorithms.

At block 406, the method 400 also includes executing, with the video scaler hardware controller, computer-readable program code of a facial sensing-to-distance data translator module to detect landmarks of the user's face within the facial patterns, detect the distance of the user's face relative to the digital display device based on the detected landmarks. Execution of the computer-readable program code instructions of the facial sensing-to-distance data translator module may, in an embodiment, detect landmarks of the user's face within the facial patterns. These landmarks may include any number of points or features of the user's face as described herein as well as each point or features' location relative to each other. Upon identification of the user's face and one or more feature points of a user's face, a distance of a user's face may be determined. Each of these points or features may be used by facial recognition software executing at the digital display device or at a coupled information handling system, in some embodiments, to identify a specific user and may be saved in a scaler memory device for later use and identification of a specific user during operation of the systems and methods described herein.

However, remaining on-board the digital display device, the execution of the computer-readable program code instructions of the facial sensing-to-distance data translator module also detects the distance of the user's face relative to the digital display device based on the detected landmarks. This is done in real-time on the digital display device without engaging processing resources or bus/wireless link communications with an operatively coupled information handling system. This distance of the user's face relative to the digital display device may be calculated using the focal length of visual sensor and a detected height of the user's face using, for example, the CMOS sensor and a microcontroller of the visual sensor. In an embodiment, those equations described in connection with FIGS. 1 and 2 (Eq. 1, Eq. 2, and/or Eq. 3) may be used to complete these calculations.

The method 400 also includes, at block 408, the video scaler hardware controller executing computer-readable program code instructions of a font setting API to interface with on-board user interface settings of the digital display device to adjust the screen scale of images displayed at the digital display device based on the detected distance of the user's face relative to the digital display device. Execution of the computer-readable program code instructions of the font setting API allows the video scaler hardware controller to interface with user interface settings of the digital display device controlled at the digital display device by the video scaler hardware controller or another microcontroller based on a generated delta displacement data calculated for a detected distance of a user from the digital display device. Execution of code instructions of the facial sensing-to-distance data translating module and distance data-to-user interface module may determine a translation of the delta displacement data into a user interface size. Thus, the font setting API allows the video scaler hardware controller to apply the appropriate ppi scaling to the text, icons, and other GUI features presented on the digital display device for adjustments based on detected distance of a user from the digital display device. In an embodiment, the video scaler hardware controller is allowed to access the video and graphics display settings in order to override any current size settings associated with the text, icons, and other GUI features presented on the digital display device as set by software setting from an operatively coupled information handling system. In this way, the execution of the facial sensing-to-distance data translating module and distance data-to-user interface module by the video scaler hardware controller of embodiments described herein may dynamically adjust the size of those text, icons, and other GUI features presented on the digital display device as the distance of the user's face relative to the digital display device changes without requiring processing or adjustment by or communication with the operatively coupled information handling system.

Because dynamic adjustments to the size or scale of the text, icons, and other GUI features presented on the digital display device in GUI data from an executing information handling system is, at least partially, dependent on a detected distance of the user relative to the digital display device. At block 410, the method 400 includes determining if changes in the distance of the user's face relative to the digital display device have been detected by the facial detection module of the visual sensor/camera and the facial sensing-to-distance data translator module executing at the video scaler hardware controller. As described herein, the calculations made to define a distance “d” between the user's face and the digital display device may be completed by the facial sensing-to-distance data translator module on either a continuous or periodic (e.g., every 10 or 15 seconds) basis in an example embodiment. As such, the facial sensor may detect any change in the distance between the user's face and the digital display device (e.g., the delta displacement data) and adjust the size or scale of the text, icons, and other GUI presented on the digital display device accordingly when the delta displacement data has been calculated. Thus, at block 410, where no delta displacement data has been calculated due to the distance between the user's face and the digital display device not changing, the method 400 continues to block 412. At block 412, the digital display device, via operation of the video scaler hardware controller, continues to process and display image and video data at the video and graphics display device with the current screen scale.

However, at block 410, where the visual sensor and video scaler hardware controller have determined that the distance of the user's face relative to the digital display device has changed and delta displacement data has been generated based on that detection, the video scaler hardware controller may execute computer-readable program code instructions of a font setting API to interface with user interface settings of the digital display device to adjust the screen scale based on the detected changes in changes in distance of those facial features relative to the digital display device. As described herein, this either increases the size or scale of the text, icons, and other GUI features presented on the standalone digital display device or decreases the size or scale of the text, icons, and other GUI features presented on the digital display device from received video data of the operatively coupled information handling system. The increase or decrease of the size of text, icons, or other GUI features presented on the standalone digital display device is determined based on distance data of a user's face from the standalone digital display device or delta displacement data for change in that distance cross-referenced with data within the user interface size look-up-table (LUT) at the scaler memory device and accessed by the video scaler hardware controller executing at the standalone digital display device. As described herein, the user interface size LUT cross-references a plurality of distances with a pixel density or pixel per inch (ppi) value to be used for display of text, icons and other GUI features thereby informing the video scaler hardware controller to what degree the text, icons, and other GUI presented on the digital display device are to be sized or scaled up or down to accommodate for the changes in the distance of the user's face relative to the digital display device.

As shown in FIG. 4, the method 400 return to block 410 to continuously determine whether the distance between the user's face and the digital display device has changed. This process continues until no change in distance has been detected at block 410 and, at block 412 the method continues with ongoing display of video data at the standalone display device at the currently set screen scale. Such a monitoring of distance changes of a detected user's face and digital display device may continue in embodiments herein until the type of video data received changes or the digital display device has been turned off as described below.

At block 416, the method may receive an indication that the display settings have changed while continuous monitoring for distance of the user's face is occurring. This may be an OS display setting changed manually by a user at the operatively coupled information handling system or that the user elects to turn off the automatic screen scale adjustment on-board the standalone digital display device in various embodiments at block 416. Where the user has not manually adjusted screen scale with the OS or has not turned off the automatic screen scale adjustment on-board the standalone digital display device, the flow proceeds to block 420 to determine if the standalone digital display device or the operatively coupled information handling system are still initiated.

Where the user has manually adjusted screen scale with the OS or has turned off the automatic screen scale adjustment on-board the standalone digital display device, such a command is forwarded to the video scaler hardware controller on the standalone digital display device and the method 400 proceeds to block 418. At block 418, the video scaler hardware controller will cease the automatic screen scale adjustment on-board the standalone digital display device and make any adjustments to screen scale for the video data received based on the manual selection or a default setting when the automatic screen scale adjustment on-board the standalone digital display device is simply turned off. Flow then proceeds to block 420 to determine if the standalone digital display device or the operatively coupled information handling system are still initiated.

Thus, at block 420, the method 400 includes determining if the digital display device is still initiated. Where the digital display device is still initiated, the method 400 returns to block 402 to monitor for video data and determine the type of received video data such that the video scaler hardware controller continues to execute the computer readable code instructions of the facial detection module on-board of the digital display device to detect a user's face with detected facial patterns via captured images and process the same to determine scaling of display for user interface elements presented on the display from received incoming video output data from the information handling system and GPU thereon when GUI-type video data is received according to embodiments herein. The video scaler hardware controller processes the incoming video output data when it is GUI-type video data from the operatively coupled information handling system pursuant to monitor for changes in distance of a user's detected face and conduct automatic screen scale adjustment on-board the standalone digital display device to dynamically adjust size of text, icons and other GUI features displayed as described in embodiments herein. Where the information handling system is no longer initiated at block 420, the method 400 may end here.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A standalone digital display device comprising:
a video scaler hardware controller, a scaler memory device, and a power supply unit (PSU) to provide power to the video scaler hardware controller and scaler storage device;
the video scaler hardware controller at the standalone digital display device to receive video data from an operatively coupled information handling system via a wired or wireless connection;
a visual sensor to capture images of a user's face;
the video scaler hardware controller to execute computer-readable program code instructions of a facial detection module to detect facial patterns of a user's face based on the captured images of the user's face at the visual sensor;
the video scaler hardware controller to execute computer-readable program code of a facial sensing-to-distance data translator module to detect facial landmarks of the user's face from the facial patterns within an image of the user's face, detect the distance of the detected facial landmarks of the user's face relative to the standalone digital display device, and detect changes in distance of those facial landmarks to generate delta distance data during operation of the standalone digital display device; and
the video scaler hardware controller to execute computer-readable program code instructions of a distance data-to-user interface size module to translate distance of the user's face to the standalone digital display device to a pixels-per-inch (ppi) screen scale adjustment to adjust the size of the displayed text, icons, or other graphical user interface (GUI) features of the video data received from the operatively coupled information handling system for display on a display screen of the standalone digital display device.

2. The standalone digital display device of claim 1, further comprising:
the video scaler hardware controller to receive additional images of the user's face from the visual sensor to monitor the delta distance data of the user's face from the standalone digital display device and dynamically adjust the ppi screen scale adjustments to the size of the displayed text, icons, or other GUI features in the video data based on the detected changes to the distance of the user's face relative to the standalone digital display device.

3. The standalone digital display device of claim 2 further comprising:
the video scaler hardware controller to execute computer-readable program code instructions of a distance data-to-user interface size module to translate the delta distance data into the ppi screen scale adjustment to dynamically adjust the size of the displayed text, icons, or other GUI features of the video data by accessing user interface size look-up table to translate a detected changed distance of a user's face to select a corresponding ppi screen scale adjustment for that detected distance of the user's face to the standalone digital display device.

4. The standalone digital display device of claim 1, wherein the video scaler hardware controller executes the computer-readable program code instructions of the distance data-to-user interface size module determine if the delta distance data meets a threshold change in distance before translating the delta distance data into the ppi screen scale adjustments to dynamically adjust the size of the displayed text, icons, or other graphical user interface (GUI) features of the received video data.

5. The standalone digital display device of claim 1 further comprising:
the video scaler hardware controller to execute the computer-readable program code instructions of the facial detection module to detect a single face of a first user among a plurality of faces in front of the visual sensor and select the single face of the first user among the plurality of faces to detect landmarks of the user's face for the first user and not of the plurality of faces detected by the visual sensor for detecting delta distance data for dynamic adjustments to the ppi screen scale adjustments to displayed text, icons, or other GUI features of the video data.

6. The standalone digital display device of claim 1 further comprising:
the video scaler hardware controller to execute the computer-readable program code instructions of the facial detection module to detect a centrally-located face among a plurality of faces of users in front of the visual sensor and select the centrally-located face to detect landmarks of the user's face for detecting distance of the centrally-located face to the standalone digital display device to determine the ppi screen scale adjustment to displayed text, icons, or other GUI features of the video data.

7. The standalone digital display device of claim 1 further comprising:
the video scaler hardware controller to execute computer-readable program code instructions of the distance data-to-user interface size module to maintain the ppi screen scale adjustment to the displayed text, icons, or other GUI features when no delta distance data has been detected above a distance change threshold value.

8. The standalone digital display device of claim 1, further comprising:
the video scaler hardware controller to execute computer-readable program code instructions of a font setting application programming interface (API) to implement the ppi screen scale adjustment to the displayed text, icons, or other GUI features for the received video data at a timing controller of the display screen for the display onboard the standalone digital display device and override display screen settings set by a software application or operating system settings at the operatively coupled information handling system to adjust the size of displayed text, icons, or other GUI features displayed on the standalone digital display device.

9. A method executing computer-readable program code instructions for adjusting a screen scale of a user interface comprising:
receiving, wired port or wireless interface adapter, video data from an operatively coupled information handling system generated pursuant to execution of a software application at the information handling system;
determining, with a video scaler hardware controller, that the received video data includes graphical user interface (GUI) data for display at the standalone digital display device;
executing, with the video scaler hardware controller onboard a standalone digital display device, computer-readable program code instructions of a facial detection module to detect facial patterns of a user's face based on the captured images of the user's face from a visual sensor;
executing, with the video scaler hardware controller, computer-readable program code of a facial sensing-to-distance data translator module to detect facial landmarks of the user's face within the facial patterns, detect the distance of a detected facial landmark of the user's face relative to the standalone digital display device, and detect changes in distance of the user's face to a generate delta distance data value; and
executing, with the video scaler hardware controller on-board the standalone digital display device, computer-readable program code instructions of a distance data-to-user interface size module to translate the detected distance of the user's face to the standalone digital display device to a pixels-per-inch (ppi) screen scale adjustment to override the default user interface size setting from the operatively coupled information handling system and adjust a size of the displayed text, icons, or other graphical user interface (GUI) features of the video data received from the operatively coupled information handling system for display on a display screen of the standalone digital display device.

10. The method of claim 9 further comprising:
executing, with the video scaler hardware controller, computer-readable program code instructions of a font setting application programming interface (API) to override the default user interface size setting from the operatively coupled information handling system and adjust the size of the displayed text, icons, or other graphical user interface (GUI) features displayed on the display screen at the standalone digital display device.

11. The method of claim 9 further comprising:
determining, with the video scaler hardware controller, that the received video data includes streaming video data for display at the standalone digital display device and not override the default user interface size setting from the operatively coupled information handling system with execution of the computer-readable program code instructions of the distance data-to-user interface size module to translate the detected distance of the user's face to the standalone digital display device for the ppi screen scale adjustment.

12. The method of claim 9 further comprising:
executing, with the video scaler hardware controller, computer-readable program code instructions of the distance data-to-user interface size module to translate the distance of the user's face to the standalone digital display device to the ppi screen scale adjustment by accessing a user interface size look-up table to select the size of the displayed text, icons, or other graphical user interface (GUI) features of the video data for display on the display screen at the standalone digital display device.

13. The method of claim 9 further comprising:
receiving additional images of the user's face from the visual sensor to monitor the delta distance data of the user's face from the standalone digital display device; and
executing, with the video scaler hardware controller, computer-readable program code instructions of the distance data-to-user interface size module to dynamically adjust the ppi screen scale adjustments to the size of the displayed text, icons, or other GUI features in the video data based on the detected changes to the distance of the user's face relative to the standalone digital display device.

14. The method of claim 9 further comprising:
executing, via the video scaler hardware controller, the computer-readable program code instructions of the distance data-to-user interface size module to determine if the delta distance data meets a threshold change in distance before translating the delta distance data into the ppi screen scale adjustment to dynamically adjust the size of the displayed text, icons, or other graphical user interface (GUI) features of the received video data.

15. A standalone digital display device comprising:
a video scaler hardware controller, a scaler memory device, and a power supply unit (PSU) to provide power to the video scaler hardware controller and scaler storage device;
the video scaler hardware controller at the standalone digital display device to receive video data from an operatively coupled information handling system via a wired or wireless connection;
a visual sensor to capture images of a user's face;
the video scaler hardware controller to execute computer-readable program code instructions of a facial detection module to detect facial patterns of a user's face based on the captured images of the user's face at the visual sensor;
the video scaler hardware controller to execute computer-readable program code of a facial sensing-to-distance data translator module to detect facial landmarks of the user's face from the facial patterns within an image of the user's face, detect the distance of the detected facial landmarks of the user's face relative to the standalone digital display device, and detect changes in distance of those facial landmarks to generate delta distance data during operation of the standalone digital display device;
the video scaler hardware controller to execute computer-readable program code instructions of a distance data-to-user interface size module to translate distance of the user's face to the standalone digital display device to a pixels-per-inch (ppi) screen scale adjustment to adjust the size of the displayed text, icons, or other graphical user interface (GUI) features of the video data received from the operatively coupled information handling system for display on a display screen of the standalone digital display device; and
the video scaler hardware controller to receive additional images of the user's face from the visual sensor to monitor the delta distance data of the user's face from the standalone digital display device and dynamically adjust the ppi screen scale adjustments to the size of the displayed text, icons, or other GUI features in the video data based on the detected changes to the distance of the user's face relative to the standalone digital display device.

16. The standalone digital display device of claim 15, wherein the video scaler hardware controller executes the computer-readable program code instructions of the distance data-to-user interface size module determine if the delta distance data meets a threshold change in distance before translating the delta distance data into the ppi screen scale adjustments to dynamically adjust the size of the displayed text, icons, or other graphical user interface (GUI) features of the received video data.

17. The standalone digital display device of claim 15, wherein the video scaler hardware controller executes the computer-readable program code instructions of the distance data-to-user interface size module determine if the received video data is streaming video data and not overriding the default user interface size setting set at the operatively coupled information handling system with execution of the computer-readable program code instructions of the distance data-to-user interface size module to translate the detected distance of the user's face to the standalone digital display device for the ppi screen scale adjustment.

18. The standalone digital display device of claim 15 further comprising:
the video scaler hardware controller receiving an instruction to turn off the execution of the distance data-to-user interface size module adjustments to the ppi screen scale on board the standalone digital display device along with the video data received from the operatively coupled information handling system; and
the video scaler hardware controller to maintain display screen settings set by a software application or operating system settings at the operatively coupled information handling system for the received video data.

19. The standalone digital display device of claim 15 further comprising:
the video scaler hardware controller to execute computer-readable program code instructions of the distance data-to-user interface size module to maintain the ppi screen scale adjustment to the displayed text, icons, or other GUI features when no delta distance data has been detected above a distance change threshold value.

20. The standalone digital display device of claim 15, further comprising:
the video scaler hardware controller to execute computer-readable program code instructions of a font setting application programming interface (API) to implement the ppi screen scale adjustment to the displayed text, icons, or other GUI features for the received video data at a timing controller of the display screen for the display onboard the standalone digital display device and override display screen settings set by a software application or operating system settings at the operatively coupled information handling system to adjust the size of displayed text, icons, or other GUI features displayed on the standalone digital display device.
